(19) United States
(12) Patent Application Publication
(10) Pub. No.: US 2006/0276573 A1
(43) Pub. Date: Dec. 7, 2006

(54) Artificial hair and a method of preparing artificial hair

(75) Inventors: Toshiyuki Masuda, Hyogo (JP); Toyohiko Shiga, Hyogo (JP); Toshihiro Kawaki, Osaka (JP)

Correspondence Address: BRINKS HOFER GILSON & LIONE, P.O. BOX 10395, CHICAGO, IL, 60610, US

(73) Assignee: Kaneka Corporation

(21) Appl. No.: 11/502,022

(22) Filed: Aug. 9, 2006

Related U.S. Application Data
(63) Continuation of application No. 10/505,300, filed on Aug. 20, 2004.

(30) Foreign Application Priority Data
Feb. 22, 2002 (JP) 2002-45760

(51) Int. Cl. C08K 5/49

(52) U.S. Cl. 524/115

(57) ABSTRACT

A flame resistant polyester fiber, while maintaining physical properties, such as heat resistance, tensile strength and elongation, etc. of usual polyester fibers, having excellent flame resistance and excellent setting property, and furthermore having controlled gloss of fiber is provided. A composition obtained by melt kneading of a polyester (A) comprising polyalkylene terephthalates, and one or more kinds of copolymerized polyesters having polyalkylene terephthalate as a principal component; a polymer alloy (B) consisting of polyalkylene terephthalates and polyarylates; phosphorus based flame resistant agents (C); and phosphite based compounds (D), and organic fine particles (E) and/or inorganic fine particles (F) are mixed thereto to obtain a composition. The obtained composition is melt spun to obtain a flame resistant polyester fiber in which the above-mentioned problems are solved, and to obtain artificial hair using the fiber.

### RELATED APPLICATIONS

This application is a continuation of U.S. application Ser. No. 10/505,300 filed Aug. 20, 2006, and is a nationalization of PCT Application No. PCT/JP03/01768 filed Feb. 19, 2003. This application claims priority from Japanese Patent Application No. 2002-45760 filed on Feb. 22, 2002.

### FIELD OF THE INVENTION

The present invention relates to a flame resistant polyester fiber formed from a composition obtained by melt kneading of polyesters, a polyarylate based polymer alloys, phosphorus based flame resistant agents, and phosphite based compound, and also relates to artificial hair using the same.

### BACKGROUND ART

Since fibers comprising polyethylene terephthalates or polyesters having polyethylene terephthalates as main constituents has a high melting point, a high elastic modulus, excellent heat resistance, and chemical resistance, they are widely used for curtains, mattings, garments, blankets, sheet ground fabrics, tablecloths, chair covering ground fabrics, wall covering materials, artificial hair, and automobile interior materials, outdoor type reinforcing materials, safety nets, etc.

Human hair, artificial hair (modacrylic fiber, polyvinyl chloride fiber), etc. have conventionally been used in hair products, such as wigs, hair wigs, false hair, hair bands, and doll hair.

However, human hair is being difficult in availability and therefore importance of artificial hair is now increasing.

Although many modacrylic fibers have been used as artificial hair materials utilizing flame resistant feature thereof, it is inadequate in respect of heat resistance.

In recent years, artificial hair is proposed that uses fibers having polyesters represented by polyethylene terephthalate with excellent heat resistance as a principal component.

However, since fibers obtained from polyesters represented by polyethylene terephthalate is of inflammable materials, it has inadequate flame resistance.

Conventionally, various attempts to improve flame resistance of polyester fibers have been performed, and there are known, for example, a method to use fibers made of polyesters copolymerized with flame resistant monomers including phosphorus, and a method to add flame resistant agents in polyester fibers.

As methods of copolymerization with the former flame resistant monomers, for example, there have been proposed a method (Japanese Patent Publication No. 55-41610 official report) of copolymerization with phosphorus compounds, giving satisfactory thermal stability, having phosphorus atom as a ring member; a method of copolymerization with carboxy phosphinic acids (Japanese Patent Publication No. 53-13479 official report); and a method of blending or copolymerization with phosphorus compounds to polyesters comprising polyarylate (Japanese Patent Laid-Open No. 11-124732 official report).

As the latter method of adding flame resistant agents, a method of inclusion of halogenated cycloalkane compounds in a shape of micro-particles to polyester fibers (Japanese Patent Publication No. 3-57990 official report); and a method of inclusion of alkyl cyclohexane comprising bromine atoms (Japanese Patent Publication No. 1-24913 official report) etc. have been proposed.

As a method of application of the flame resistance technique to artificial hair, for example, polyester fibers copolymerized with phosphorus compounds are proposed (Japanese Patent Laid-Open No. 3-27105 official report, Japanese Patent Laid-Open No. 5-339805 official report, etc.)

However, since artificial hair requires high flame resistance, use of these copolymerized polyester fibers require a great amount of copolymerization, other problems may occur that the copolymerization greatly reduces heat resistance of the polyester and makes melt spinning difficult, and also may induce melting and dripping although not causing firing and burning, in approach to a flame.

On the other hand, in methods of inclusion of flame resistant agent in polyester fibers, there may be problems that a high treatment temperature for inclusion as not less than 150 degrees C. is required in order to obtain sufficient flame resistance, a long processing period of time for inclusion is required, and use of a large quantity of flame resistant agents is required. As a result, problems of decrease in fiber physical properties, decrease in productivity, and manufacturing cost rising may arise.

Thus, artificial hair having excellent setting property is not yet obtained, while maintaining fiber physical properties, such as flame resistance, heat resistance, strength, elongation, etc. of conventional polyester fibers.

In order to solve conventional problems mentioned above, the present invention aims at providing a flame resistant polyester fiber, while maintaining physical properties, such as heat resistance, tensile strength and elongation, etc. of usual polyester fibers, having excellent flame resistance and excellent setting property, and furthermore having controlled gloss of fiber, and also aims at providing artificial hair using the same.

### SUMMARY OF THE INVENTION

As a result of repeated investigation wholeheartedly carried out by the present inventors in order to solve the above-mentioned problems, it was found out that a flame resistant polyester fiber, while maintaining physical properties, such as heat resistance, tensile strength and elongation, etc. of usual polyester fibers, having excellent flame resistance and excellent setting property might be obtained, by melt spinning a composition obtained by melt kneading of polyesters, polyarylate based polymer alloys, phosphorus based flame resistant agents, and phosphite based compounds, and furthermore it was found out that gloss of fiber might be controllable without causing decrease in physical properties of the fibers by mixing organic fine particles and/or inorganic fine particles to the composition, leading to completion of the present invention.

That is, the present invention relates to a flame resistant polyester fiber comprising:
(A) a polyester comprising polyalkylene terephthalates, and one or more kinds of copolymerized polyesters having polyalkylene terephthalate as a principal component;
(B) a polymer alloy consisting of polyalkylene terephthalates and polyarylates;
(C) phosphorus based flame resistant agents; and
(D) phosphite based compounds.

Preferably, a weight ratio of the component (A) and the component (B) is (A)/(B)=90/10 to 50/50, and also the component (C) is 0.05 to 10 parts by weight, the component (D) is 0.05 to 5 parts by weight in terms of phosphorus atomic weight with respect to a total amount of component (A) and component (B) 100 parts by weight.

The components (A) are preferably at least one kind of polymers selected from a group consisting of polyethylene terephthalates, polypropylene terephthalates, and polybutylene terephthalates.

Preferably the component (B) is an polymer alloy consisting of:
at least one kind of polyalkylene terephthalates selected from a group consisting of polyethylene terephthalates, polypropylene terephthalates, and polybutylene terephthalates; and a polyarylate obtained from a mixture of terephthalic acid and/or terephthalic acid derivatives and isophthalic acid and/or isophthalic acid derivatives, and bisphenol compounds represented with a general formula (1). 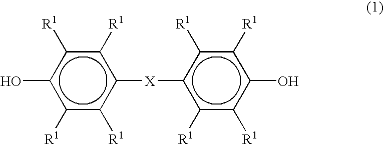
   (Where, R¹ is hydrogen atom, or hydrocarbon group with 1 to 10 carbon atoms, and may be identical or different respectively, X represents methylene group, ethylidene group, isopropylidene group, carbonyl group, sulfonyl group, 1,3-phenylene diisopropylidene group or 1,4-phenylene diisopropylidene group.)

Preferably, the component (C) is at least one kind of compounds selected from a group consisting of phosphate based compounds, phosphonate based compounds, phosphinate based compounds, phosphine oxide based compounds, phosphonite based compound, phosphinite based compounds, phosphine based compounds, and condensed phosphoric acid ester compounds.

Preferably, the component (C) is a condensed phosphoric acid ester compound represented with a general formula (2). 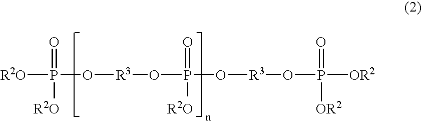
(Where, R² is monovalent aromatic hydrocarbon group or aliphatic hydrocarbon group, which may be identical of different respectively, R³ is a divalent aromatic hydrocarbon group, and when two or more are included they may be identical or different respectively, n represents an integer of 0 to 15.)

The component (C) is preferably a reactive phosphorus based flame resistant agent being copolymerizable with the component (A).

The reactive phosphorus based flame resistant agent is preferably at least one kind selected from a group consisting of phosphorated compounds represented with general formulas (3) to (8). 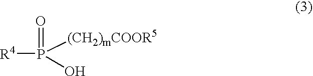
(Where, R⁴ is aliphatic hydrocarbon group with 1 to 20 carbon atoms or aromatic hydrocarbon group with 6 to 12 carbon atoms, R⁵ is hydrogen atom or aliphatic hydrocarbon group with 1 to 20 carbon atoms, m represents an integer of 1 to 11.) 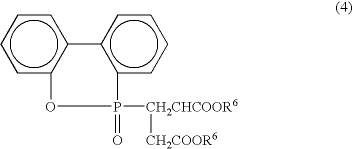
(Where, R⁶ is hydrogen atom or aliphatic hydrocarbon group with 1 to 20 carbon atoms, and they may be identical or different respectively.) 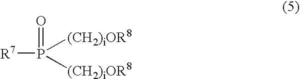
(Where, R⁷ is aliphatic hydrocarbon group with 1 to 20 carbon atoms or aromatic hydrocarbon group with 1 to 12 carbon atoms, R⁸ is hydrogen atom or aliphatic hydrocarbon group with 1 to 20 carbon atoms, and they may be identical or different respectively, and 1 represents an integer of 1 to 12.) 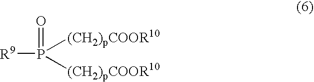
(Where, R⁹ is an aliphatic hydrocarbon group with 1 to 20 carbon atoms or aromatic hydrocarbon group with 6 to 12 carbon atoms, R¹⁰ is hydrogen atom or aliphatic hydrocarbon group with 1 to 20 carbon atoms, they may be identical or different respectively, and p represents an integer of 1 to 11.) 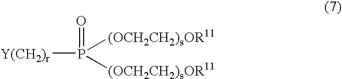
(Where, R¹¹ is hydrogen atom or aliphatic hydrocarbon group with 1 to 20 carbon atoms, and they may be identical or different respectively, and Y is hydrogen atom, methyl group, or aromatic hydrocarbon group with 6 to 12 carbon atoms, and r and s represent integers of 1 to 20, respectively.) and 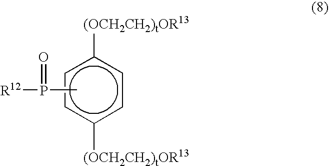
(Where, R¹² is aliphatic hydrocarbon group with 1 to 20 carbon atoms or aromatic hydrocarbon group with 6 to 12 carbon atoms, R¹³ is hydrogen atom or aliphatic hydrocarbon group with 1 to 20 carbon atoms, and they may be identical or different respectively, and t represents an integer of 1 to 20.)

The component (D) is preferably at least one kind selected from a group consisting of trialkylphosphites, triaryl phosphates, alkyl aryl phosphites, and phosphite based compounds represented with general formulas (9) to (12). 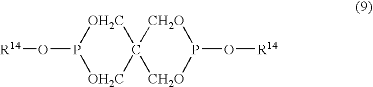
(Where, R¹⁴ is linear or branched hydrocarbon group with 4 to 20 carbon atoms, and they may be identical or different respectively.) 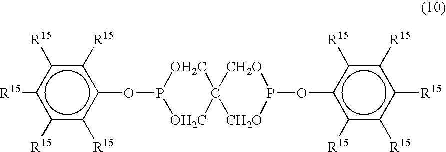
(Where, R¹⁵ is hydrogen atom or hydrocarbon group with 1 to 10 carbon atoms, and they may be identical or different respectively.) 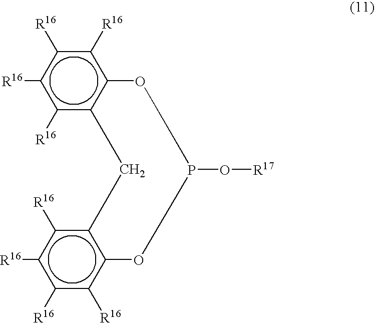
(Where, R¹⁶ is hydrogen atom or hydrocarbon group with 1 to 10 carbon atoms, and they may be identical or different respectively, and R¹⁷ is hydrocarbon group with 4 to 20 carbon atoms or aromatic hydrocarbon group with 6 to 20 carbon atoms.) 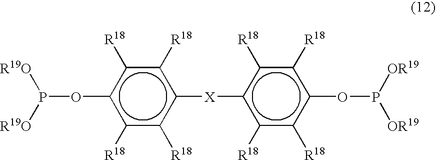
(Where, R¹⁸ is hydrogen atom or hydrocarbon group with 1 to 10 carbon atoms, and they may be identical or different respectively, and R¹⁹ is hydrocarbon group with 4 to 20 carbon atoms or aromatic hydrocarbon group with 6 to 20 carbon atoms and they may be identical or different respectively, and X represents methylene group, ethylidene group, isopropylidene group, carbonyl group, sulfonyl group, 1,3-phenylene diisopropylidene group or 1,4-phenylene diisopropylidene group.)

Preferably, organic fine particles (E) and/or inorganic fine particles (F) are further mixed into a composition comprising the component (A) to the component (D).

The component (E) is preferably at least one kind selected from a group consisting of polyarylates, polyamides, fluororesins, silicone resins, cross-linked acrylate resins, and cross-linked polystyrenes.

The component (F) is preferably at least one kind selected from a group consisting of calcium carbonate, silicon oxide, titanium oxides, aluminum oxide, zinc oxide, talc, kaolin, montmorillonite, bentonite, and mica.

The flame resistant polyester fiber preferably has non-crimped flat yarn shape.

The flame resistant polyester fiber is preferably spun dyed.

The flame resistant polyester fiber is yarn for artificial hair.

It is related with artificial hair comprising flame resistant polyester fiber.

### BEST MODE FOR CARRYING-OUT OF THE INVENTION

A flame resistant polyester fiber of the present invention is a composition obtained by melt kneading: a polyester (A) consisting of one or more kinds of polyalkylene terephthalate, and copolymerized polyester having polyalkylene terephthalate as a principal component; a polymer alloy (B) consisting of polyethylene terephthalate and polyarylate; a phosphorus based flame resistant agent (C); and a phosphite based compound (D), and it is a fiber obtained by melt spinning a composition obtained by further adding and mixing organic fine particles (E) and/or inorganic fine particles to a composition comprising the above-mentioned components.

In the present invention, the polyester (A) is a component used for a fiber-forming base polymer, the polymer alloy (B) consisting of polyalkylene terephthalates and polyarylates is a component used for improvement in drip-proof property, the phosphorus based flame resistant agent (C) is a component used for exhibiting flame resistance, the phosphite based compound (D) is a component used for controlling ester interchange between the components (A) and (B), and the organic fine particles (E) and inorganic fine particles (F) are components for forming minute projection on a surface of the fiber obtained by melt spinning.

The polyester (A) used for the present invention consists of polyalkylene terephthalate, and one or more kinds of copolymerized polyester having polyalkylene terephthalate as a principal component.

From a viewpoint of heat resistance, mechanical property, ease of availability, and cost, as polyalkylene terephthalate, polyethylene terephthalate, polypropylene terephthalate, and polybutylene terephthalate are preferable.

As copolymerized polyesters having polyalkylene terephthalate as a principal component, copolymerized polyesters having polyalkylene terephthalate as a principal component, and having a small quantity of copolymerizable components included may be mentioned.

Here, an expression of “having as a principal component” means “including not less than 80 mol % in the polyester (A)”.

The copolymerizable component, for example, includes multivalent carboxylic acid, such as isophthalic acid, ortho-phthalic acid, naphthalene dicarboxylic acid, para phenylene dicarboxylic acid, trimellitic acid, pyromellitic acid, succinic acid, glutaric acid, adipic acid, suberic acid, azelaic acid, sebacic acid, and dodecane diacid, and derivatives the above-mentioned multivalent carboxylic acids; dicarboxylic acid comprising sulfonate, such as 5-sodium sulfo isophthalic acid and 5-sodium sulfo isophthalic acid dihydroxy ethyl, and derivatives the above-mentioned dicarboxylic acids; and furthermore 1,2-propanediol, 1,3-propanediol, 1,4-butanediol, 1,6-hexanediol, neo pentyl glycol, 1,4-cyclohexane dimethanol, diethylene glycol, polyethylene glycol, trimethylol propane, pentaerythritol, 4-hydroxybenzoic acid, ε-caprolactone, etc.

In copolymerized polyesters, usually, from a viewpoint of stability and simplicity in operation, a manufacturing method is preferable in which a small quantity of a copolymerizable component is added into a polymer of terephthalic acid and/or a derivative thereof (for example, methyl terephthalate) existing as a principal component and alkylene glycol, and then reaction is carried out. And, a monomer or an oligomer component as a small quantity of copolymerizable components may further be added into a mixture of terephthalic acid and/or a derivative thereof (for example, methyl terephthalate) existing as a principal component and alkylene glycol, and then polymerized.

In the copolymerized polyester, a copolymerizable component should just be polycondensated to a principal chain and/or a side chain of the polyalkylene terephthalate existing as a principal component, and methods of copolymerization etc. are not especially limited.

As examples of copolymerized polyesters, for example, polyesters, having polyethylene terephthalate as a principal component, obtained by copolymerization with ethylene glycol ether of bisphenol A; copolymerization of 1,4-cyclohexane dimethanol; and copolymerization with 5-sodium sulfo isophthalic acid dihydroxy ethyl may be mentioned. Among them, from a viewpoint of heat resistance and easy manufacturing, a polyester by copolymerization with ethylene glycol ether of bisphenol A, and a polyester by copolymerization with 1,4-cyclohexane dimethanol are preferable.

The polyalkylene terephthalate and copolymerized polyester may be used independently, or two or more kinds may be used in combination.

Intrinsic viscosity of the component (A) is preferably 0.5 to 1.4, and more preferably 0.6 to 1.2. An intrinsic viscosity less than 0.5 shows tendency for mechanical strength of the fiber obtained to fall, and an intrinsic viscosity exceeding 1.4 makes melt viscosity higher with increase of molecular weight, and shows tendency of making melt spinning difficult or of causing ununiformity of size of the fiber.

As mentioned above, the polymer alloy (B) used in the present invention consisting of polyalkylene terephthalates and polyarylates is a component used for improvement in drip-proof property, and is a resin having a high melt viscosity.

The component (B) is obtained by polymer alloying of ester interchange reaction of polyalkylene terephthalates, and polyarylates as an wholly aromatic polyester consisting of aromatic dicarboxylic acid components and aromatic diol components. The component (B) prepared using a single screw extruder, a twin screw extruder, rolls, a Banbury mixer, a kneader, etc. can be used. Furthermore, the component (B) may also be manufactured by reacting polyalkylene terephthalates having hydroxyl groups in terminal groups thereof, and polyarylates having hydroxyl groups in terminal groups thereof, using terephthalic acid and/or derivative thereof (for example, terephthalic acid dichloride), compounds having two isocyanate groups (for example, tolylene diisocyanate) etc.

As polyalkylene terephthalates used for manufacture of the component (B), polyethylene terephthalates, polypropylene terephthalates, and polybutylene terephthalates may be mentioned.

As polyarylates, for example, there may be mentioned, but not limited to, polyarylates obtained from aromatic dicarboxylic acid components, such as aromatic dicarboxylic acids, such as terephthalic acid, isophthalic acid, ortho-phthalic acid, naphthalene dicarboxylic acid, and para phenylene dicarboxylic acid; aromatic dicarboxylic acid derivatives, such as sulfonate of 5-sodium sulfo isophthalic acid and 5-sodium sulfo isophthalic acid dihydroxy ethyl etc.; and aromatic diol components, such as divalent phenols represented with, for example, a general formula (1). 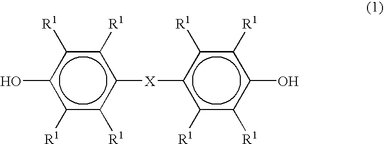
(Where, R¹ is hydrogen atom or hydrocarbon group having 1 to 10 carbon atoms, and they may be identical or different respectively, X represents methylene group, ethylidene group, isopropylidene group, carbonyl group, sulfonyl group, 1,3-phenylene diisopropylidene group, or 1,4-phenylene diisopropylidene group.) and aromatic diol components such as resorcinol, hydroquinone, biphenol, bis(4-hydroxy phenyl) methane, bis(4-hydroxyl phenyl)ether, bis(4-hydroxy phenyl)sulfone, bis(4-hydroxy phenyl) sulfide, bis(4-hydroxy phenyl)sulfone, bis(4-hydroxy phenyl)ketone, bis(4-hydroxy phenyl)diphenylmethane, bis(4-hydroxy phenyl)-p-diisopropyl benzene, bis(3,5-dimethyl-4-hydroxy phenyl)methane, bis(3-methyl-4-hydroxy phenyl)methane, bis(3,5-dimethyl-4-hydroxy phenyl)ether, bis(3,5-dimethyl-4-hydroxy phenyl)sulfone, bis(3,5-dimethyl-4-hydroxy phenyl)sulfide, 1,1-bis(4-hydroxy phenyl)ethane, 1,1-bis(3,5-dimethyl-4-hydroxy phenyl)ethane, 1,1-bis(4-hydroxy phenyl)cyclohexane, 1,1-bis(4-hydroxy phenyl)-3,3,5-trimethyl cyclohexane, 1,1-bis(4-hydroxy phenyl)-1-phenyl ethane, 2,2-bis(4-hydroxy phenyl)propane, 2,2-bis(4-hydroxy phenyl) butane, 2,2-bis (3,5-dimethyl-4-hydroxy phenyl)propane, 2,2-bis(3-methyl-4-hydroxy phenyl)propane, 4,4′-dihydroxyl biphenyl, 3,3,5,5′-tetra-methyl-4,4′-dihydroxy biphenyl, 4,4′-dihydroxy benzophenone, 4,4′-dihydroxy diphenyl ether, 4,4′-dihydroxy diphenyl thioether, etc.

Among them, from a viewpoint of easiness in availability, cost, and easiness in preparation of polymer alloys with polyalkylene terephthalates, polyarylates consisting of a mixture of terephthalic acid and/or terephthalic acid derivative and isophthalic acid and/or isophthalic acid derivative, and divalent phenols represented with the general formula (1) are preferable.

A ratio of polyalkylene terephthalate and polyarylate constituting the component (B) is preferably 5/95 to 50/50, and more preferably 10/90 to 40/60. A larger percentage of polyalkylene terephthalate than the range shows a tendency of decrease in heat resistance of the polymer alloy component obtained, and also a tendency of expression of characteristics of the polyarylate component to be difficult is shown. On the other hand, a lesser percentage worsens compatibility with the component (A), and therefore a tendency of difficulty in being compatible, semi-compatible, or being dispersed in a state of micro particles in component (A) may be shown.

An intrinsic viscosity of the component (B) is preferably 0.5 to 1.4, and more preferably 0.6 to 1.2. An intrinsic viscosity less than 0.5 reduces mechanical properties of the fiber obtained, an intrinsic viscosity exceeding 1.4 raises melt viscosity with increase in molecular weight, and makes melt spinning difficult, leading to uneven fiber size in some case.

Phosphorus based flame resistant agents (C) used in the present invention is not especially limited, but any generally used phosphorus based flame resistant agents may be used. Here, as the phosphorus based flame resistant agent (C), non-copolymerizable phosphorus based flame resistant agent may be mixed with other components for use, and reactive phosphorus based flame resistant agents may be copolymerized to the component (A) for use.

As non-copolymerizable component (C), phosphate based compounds, phosphonate based compounds, phosphinate based compounds, phosphine oxide based compounds, phosphonite based compounds, phosphinite based compounds, phosphine based compounds, for example, condensed phosphoric acid ester based compounds represented with a general formula (2) may be mentioned. 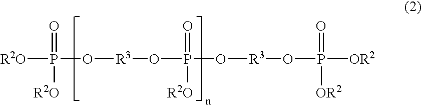
(Where, R² is monovalent aromatic hydrocarbon group or aliphatic hydrocarbon group, they may be identical or different respectively, and R³ is divalent aromatic hydrocarbon group, and when two or more groups are included, they may be identical or different, and n represents an integer 0 to 15.) These may be used independently or two or more kinds may be used in combination. Among them, from a viewpoint of lesser influence on heat resistance, resistance to hydrolysis, and physical properties of the fiber, condensed phosphoric acid ester based compounds represented with the general formula (2) are preferable.

Examples of non-copolymerizable phosphorus based flame resistant agents (C) include: trimethyl phosphate, triethyl phosphate, tributyl phosphate, tri(2-ethyl hexyl)phosphate, triphenyl phosphate, tricresyl phosphate, trixylenylphosphate, tris(isopropylphenyl)phosphate, tris(phenylphenyl)phosphate, tri nephtyl phosphate, cresyl phenyl phosphate, xylenyl diphenyl phosphate, triphenyl phosphine oxide, tricresyl phosphine oxide, methane phosphonic acid diphenyl, phenylphosphonic acid diethyl, etc. and furthermore, resorcinol polyphenyl phosphate, resorcinol poly(di-2,6-xylyl)phosphate, bisphenol A poly cresyl phosphate, hydroquinone poly(2,6-xylyl)phosphate, and compounds represented with formulas:

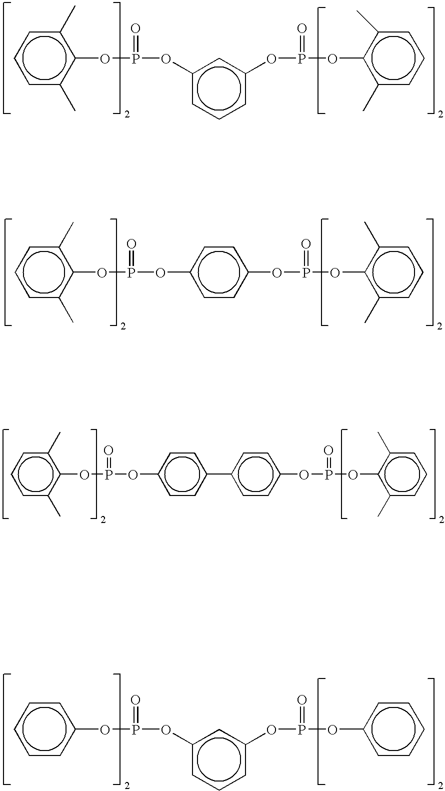

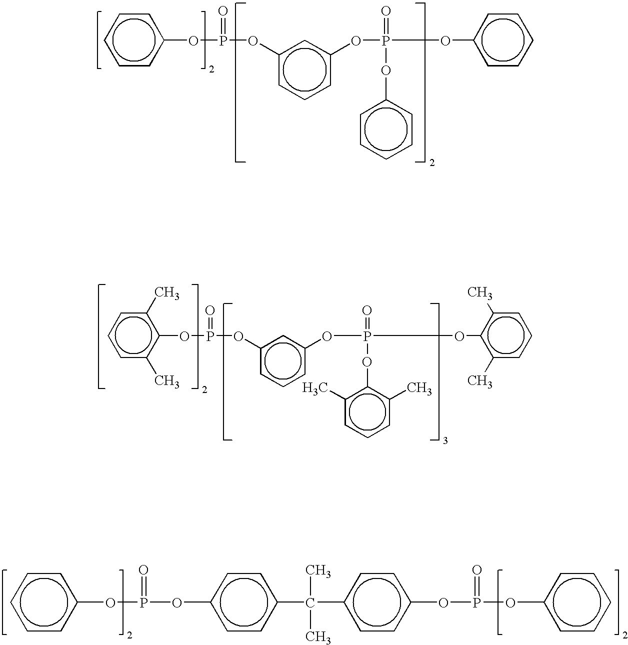

Moreover, from a viewpoint of control of decrease in physical properties of the fiber caused by copolymerization with flame resistant agents, and of realization of high flame resistant, reactive phosphorus based flame resistant agents (C) are preferable.

As the reactive components (C), reactive phosphorus based flame resistant agents copolymerizable with the component (A) may be used without any limitation, and from a viewpoint of copolymerizability, heat resistance and flame resistance, they are preferably at least one kind selected from a group consisting of phosphorus based compounds represented with general formulas (3) to (8). 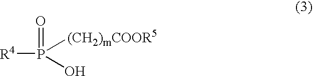
(Where, R⁴ is aliphatic hydrocarbon group having 1 to 20 carbon atoms or aromatic hydrocarbon group having 6 to 12 carbon atoms, R⁵ is hydrogen atom or aliphatic hydrocarbon group having 1 to 20 carbon atoms and m represents an integer of 1 to 11.) 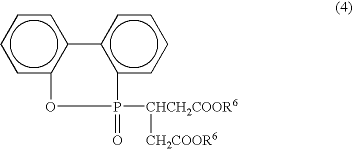
(Where, R⁶ is hydrogen atom or aliphatic hydrocarbon group having 1 to 20 carbon atoms, and they may be identical or different respectively.) 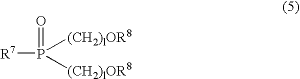
(Where, R⁷ is aliphatic hydrocarbon group with 1 to 20 carbon atoms or aromatic hydrocarbon group having 6 to 12 carbon atoms, and R⁸ is hydrogen atom or aliphatic hydrocarbon group having 1 to 20 carbon atoms, and they may be identical or different respectively, and 1 represents an integer of 1 to 12.) 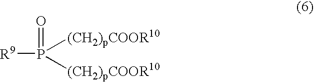
(Where, R⁹ is aliphatic hydrocarbon group having 1 to 20 carbon atoms or aromatic hydrocarbon group having 6 to 12 carbon atoms, and R¹⁰ is hydrogen atom or aliphatic hydrocarbon group having 1 to 20 carbon atoms and they may be identical or different respectively, and p represents an integer of 1 to 11.) 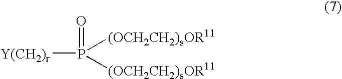
(Where, R¹¹ is hydrogen atom or aliphatic hydrocarbon group having 1 to 20 carbon atoms, and they may be identical or different respectively, and Y is hydrogen atom, methyl group, or aromatic hydrocarbon group having 6 to 12 carbon atoms, and r and s represent integers of 1 to 20, respectively.) 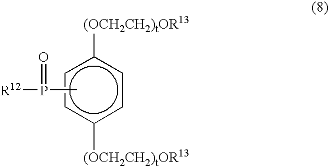
(Where, R¹² is aliphatic hydrocarbon group having 1 to 20 carbon atoms or aromatic hydrocarbon group having 6 to 12 carbon atoms, and R¹³ is hydrogen atom or aliphatic hydrocarbon group having 1 to 20 carbon atoms, and they may be identical or different respectively, and t represents an integer of 1 to 20.)

Among them, reactive phosphorus based flame resistant agents represented with the general formulas (4) and (8) are preferable from a viewpoint of physical properties of the fiber and flame resistance.

Examples, for example, include diethyl-N,N-bis(2-hydroxyethyl)amino methyl phosphonate, 2-methacrylyl oxy-ethyl acid phosphate, diphenyl-2-methacrylyl oxy-ethyl phosphate, tris(3-hydroxypropyl)phosphine, tris(4-hydroxy butyl)phosphine, tris(3-hydroxypropyl)phosphine oxide, tris(3-hydroxy butyl)phosphine oxide, 3-(hydroxy phenyl phosphinoyl)propionic acid, and furthermore compounds represented with following formulas.

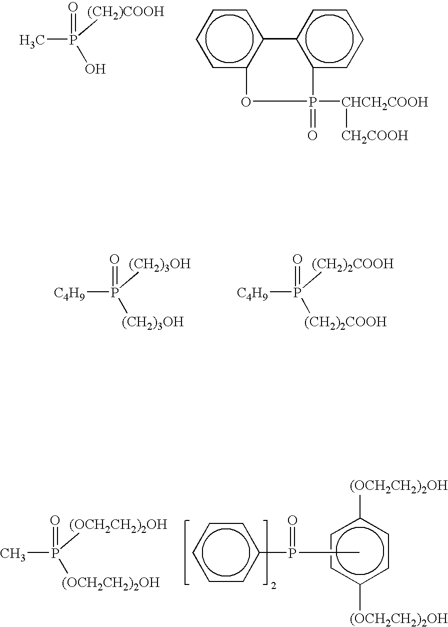

Well-known methods can be used in manufacture of thermoplastic copolymerizable polyesters for copolymerization with reactive phosphorus based flame resistant agents. Preferable examples include methods in which dicarboxylic acids and derivatives thereof, diol components and derivatives thereof, and reactive phosphorus based flame resistant agents are mixed to carry out polycondensation, and methods in which after depolymerization of thermoplastic polyesters using diol components, such as ethylene glycol, and reactive phosphorus based flame resistant agents are mixed for additional polycondensation to obtain copolymers etc.

As mentioned above, the phosphite based compound (D) used in the present invention is used in order to inhibit ester interchange reaction between the component (A) and the component (B), and trialkyl phosphites, triallyl phosphites, and alkyl allyl phosphites, and furthermore phosphite based compounds, such as phosphite based anti-oxidants represented with general formulas (9) to (12), etc. may be mentioned. 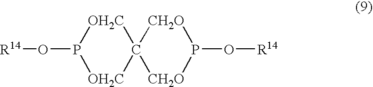
(Where, R¹⁴ is linear or branched hydrocarbon group having 4 to 20 carbon atoms, and they may be identical or different respectively.) 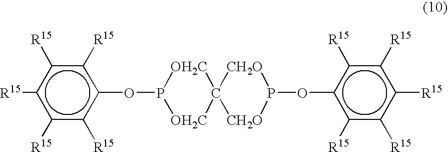
(Where, R¹⁵ is hydrogen atom or hydrocarbon group having 1 to 10 carbon atoms, and they may be identical or different respectively.) 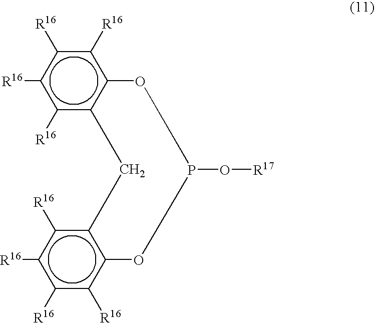
(Where, R¹⁶ is hydrogen atom or hydrocarbon group having 1 to 10 carbon atoms, and they may be identical or different respectively, and R¹⁷ is hydrocarbon group having 4 to 20 carbon atoms or aromatic hydrocarbon group having 6 to 20 carbon atoms.) 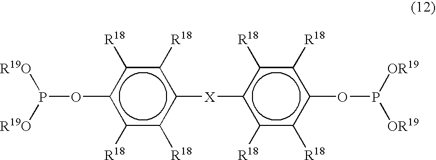
(Where, R¹⁸ is hydrogen atom or hydrocarbon group having 1 to 10 carbon atoms, and they may be identical or different respectively, and R¹⁹ is hydrocarbon group having 4 to 20 carbon atoms or aromatic hydrocarbon group having 6 to 20 carbon atoms, and they may be identical or different respectively, and X represents methylene group, ethylidene group, isopropylidene group, carbonyl group, sulfonyl group, 1,3-phenylene diisopropylidene group and 1,4-phenylene diisopropylidene group.)

Among them, from a viewpoint of ester interchange depression effect phosphite based compounds represented with the general formulas (9) and (10) are preferable.

As examples of the trialkylphosphites as the component (D), triallyl phosphites, alkyl allyl phosphites, and phosphite based compounds, such as phosphite based anti-oxidant, represented with general formulas (9) to (12), for example trialkyl phosphites, such as trioctyl phosphite and tri decanyl phosphite, alkyl allyl phosphites, such as triphenyl phosphite, tris(nonyl phenyl)phosphite, tris(2,4-di(t-butyl)phenyl)phosphite, triallyl phosphites, didecanyl phenyl phosphite, decanyl diphenyl phosphite, and octyl diphenyl phosphite, and furthermore compounds represented with following formulas may be mentioned. 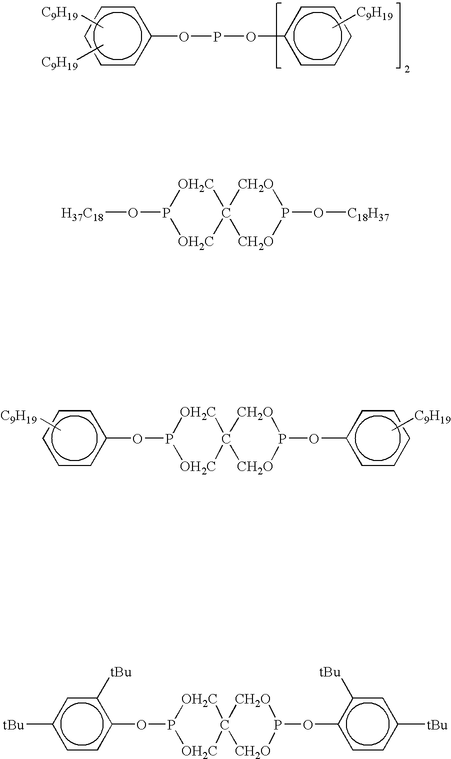 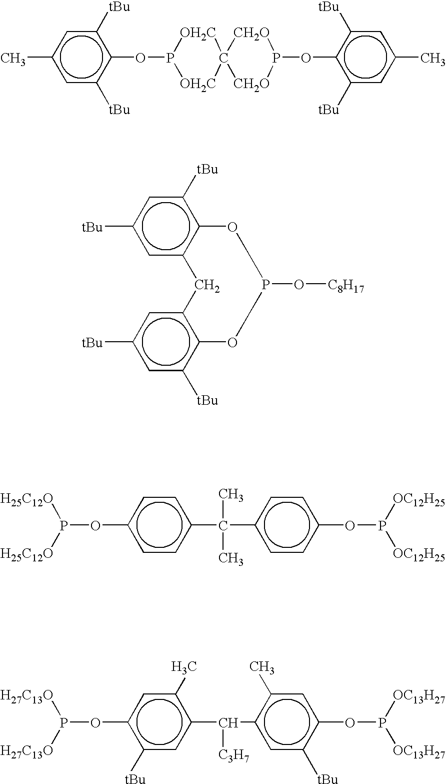
These may be used independently or two or more kinds may be used in combination.

A ratio to be used of the polyester of component (A), and the polymer alloy of component (B) is preferably (A)/(B)=90/10 to 50/50, and more preferably 88/12 to 55/45 in terms of weight ratio. A larger percentage of the component (A) than in the range does not allow expression of drip-proof property improving effect, and on the other hand, a smaller percentage reduces mechanical property and thermal property, or excessively raises melt viscosity to make melt spinning difficult.

An amount of phosphorus based flame resistant agents (C) of the component (C) is preferably 0.05 to 10 parts by weight in terms of phosphorus atomic weight to a total amount of the component (A) and the component (B) 100 parts by weight, and more preferably 0.1 to 8 parts by weight. An amount of component (C) of less than 0.05 parts by weight makes fire-resistant effect difficult to be obtained, and an amount more than 10 parts by weight tends to impair mechanical property.

Moreover, when the phosphorus based flame resistant agent (C) is a reactive phosphorus based flame resistant agent, it is preferably in a range of 0.01 to 8% by weight to an amount of the component (A) in terms of phosphorus atomic weight, more preferably 0.05 to 5% by weight, and still more preferably 0.1 to 3% by weight. An amount used smaller than 0.01% by weight makes flame resistant effect difficult to be obtained, and amount more than 8% by weight tends to impair mechanical property.

An amount of the phosphite based anti-oxidant (D) of the component (D) is preferably 0.05 to 5 parts by weight to a total amount of the component (A) and the component (B) 100 parts by weight, and more preferably 0.1 to 3 parts by weight. An amount added of the component (D) less than 0.05 parts by weight makes control of ester interchange reaction difficult, and as a result tends to reduce mechanical property and make matte effect difficult to be obtained. An amount exceeding 5 parts by weight reduces heat resistance and mechanical property of the fiber to be obtained, and easily makes yarn breakage to occur at the time of melt spinning processing caused by decrease in a melt viscosity, resulting in unstable process.

A flame resistant polyester based composition used for the present invention may be manufactured by carrying out, for example, melt-kneading after dry blending of components (A), (B), (C), and (D) using various common kneading machines.

As examples of the kneading machine, for example, a single screw extruder, a twin screw extruder, rolls, a Banbury mixer, a kneader, etc. may be mentioned. Among them, from a viewpoint of adjustment of degree of kneading and simple operation, a twin screw extruder is preferable.

In melt kneading of the components (A), (B), (C), and (D), ester interchange reaction depression effect of the phosphite based compound of the component (D) controls ester interchange reaction between the components (A) and (B), and thus melt kneading is performed.

In a flame resistant polyester fiber of the present invention, organic fine particles (E) and/or inorganic fine particles (F) are mixed into a composition comprising the above-mentioned component (A) to component (D), and minute projections are formed on a surface of the fiber thereby, enabling adjustment of gloss and luster of the surface of the fiber.

As long as a component (E) is an organic resin component having a structure compatible or partially incompatible with the component (A) and/or component (B) as principal components, any of the components (E) can be used. For example, polyarylates, polyamides, fluororesins, silicone resins, cross-linked acrylate resins, cross-linked polystyrenes, etc. may be mentioned. These may be used independently or two or more kinds may be used in combination.

The component (F) has preferably a refractive index similar to a refractive index of the component (A) and/or component (B) from a viewpoint of influence to transparency, and coloring property of the fiber, and for example, calcium carbonate, silicon oxides, titanium oxides, aluminum oxide, zinc oxide, talc, kaolin, montmorillonite, bentonite, mica, etc. may be mentioned. Among them, from a viewpoint of small influence of transparency decrease in the fiber, matting effect and cost, silicon oxide, titanium oxide, and talc are preferable.

The component (E) and the component (F) may be used independently, respectively, and both of them may be used in combination. An amount added of the component (E) and the component (F) is preferably 0.05 to 5 parts by weight in total to a total amount of the component (A) and the component (B) 100 parts by weight, and more preferably in a range of 0.1 to 4 parts by weight. An amount added of the component (E) and the component (F) of less than 0.05 parts by weight makes expression of sufficient matting effect difficult, and an amount added more than 5 parts by weight cause excessive decrease in gloss, and decrease in mechanical property. Here, the component (E) and the component (F) may preferably be added and mixed into a composition obtained by melt kneading of the component (A) to the component (D), then subjected to melt spinning, and optionally they may be mixed with the component (A) to the component (D) before melt kneading, and then melt kneading may be carried out.

A flame resistant polyester fiber of the present invention may be manufactured by melt spinning the polyester based composition using usual melt spinning methods.

That is, for example, temperatures of an extruder, a gear pump, a nozzle, etc. are set as 270 to 310 degrees C., melt spinning is performed, after passes through a heating chamber, extruded yarns are cooled to a temperature not more than a glass transition point, and extruded yarns are taken up at a rate of 50 to 5000 m/minute to obtain a yarn. It is also possible to control a size of the yarn by cooling the extruded yarns in a tank containing water for cooling. A temperature and a length of the heating chamber, a temperature and an amount of blowing cooling air, a temperature of a cooling water pool, a cooling period, and taking up velocity may appropriately be adjusted by an amount of discharge, and a number of holes of the nozzle.

Hot drawing of the obtained non-drawn yarn is carried out. Drawing may be performed any one of a two-step process method in which the non-drawn yarn is once taken up and then drawn, and a direct spinning drawing method in which drawing is performed continuously without taken up. Hot drawing is performed by a one-step drawing method or a two-or-more-step of multistage drawing method. As heating means in hot drawing, a heating roller, a heat plate, a steam jet equipment, a warm water tub, etc. can be used, and these can also be appropriately used in combination.

Various additives other than the component (C), such as flame resistant agents, heat resistant agents, light stabilizers, fluorescence agents, antioxidants, antistatic agents, pigments, plasticizers, and lubricants, may be added in a flame resistant polyester fiber of the present invention if needed. Inclusion of pigments can provide spun dyed fibers.

A flame resistant polyester fiber of the present invention thus obtained is non-crimped flat yarn-like fiber, and preferably, as artificial hair, has a size of a fiber of usually 30 to 70 dtex, and more preferably 35 to 65 dtex; strengths of 1.0 to 4.0 cN/dtex, and more preferably 1.2 to 3.0 cN/dtex; elongation of 25% to 60%, and more preferably 30% to 50%; and limiting oxygen index of 25 to 30. Besides, it is preferable, as a fiber for artificial hair, to have heat resistance for use of cosmetics heat instrument (hair irons) at a temperature of 160 to 180 degrees C., flame resistance, and self-extinguishing property. Furthermore, as a fiber for artificial hair, it preferably to have gloss adjusted to a level similar to human hair to visual observation under sunlight.

When a flame resistant polyester fiber of the present invention is spun dyed, the fiber may be used without any after treatment, but when not spun dyed, it can be dyed under similar conditions as usual flame resistant polyester fiber.

Pigments, dyestuffs, auxiliary agents, etc. to be used for dyeing preferably have satisfactory weather resistance and satisfactory flame resistance.

A flame resistant polyester fiber of the present invention has excellent curling setting property and maintenance of curling to use of cosmetics heat instrument (hair irons). Unevenness of fiber surface can give moderate matting effect, and therefore it can be used as artificial hair.

Furthermore, use of oils, such as fiber surface treating agents and softening agents, can give touch and hand to the fiber, and therefore the fiber can be more similar to human hair. When using a flame resistant polyester fiber of the present invention as artificial hair, it may be used together with other artificial hair materials, such as modacrylic fibers, polyvinyl chloride fibers, and nylon fibers, and moreover with human hair.

Hereinafter, the present invention is still more specifically described based on Examples, but the present invention is not limited to these.

Measuring methods of characteristic values will hereinafter be described.

(Strength and Elongation)

A filament was measured for a tensile elongation and strength using INTESCO Model 201 type made by INTESCO Co., ltd. One filament with a length of 40 mm was sampled, both ends of the filament was sandwiched by 10 mm with cardboard (thin paper) with which double-stick tape having adhesives thereon is attached, and after air dried overnight, and a sample with a length of 20 mm was prepared. The obtained sample was clamped with a testing machine, examination was performed under conditions of temperature of 24 degrees C., not more than 80% of humidity, load 1/30 gf×size of a fiber (denier), and a speed of testing/minute of 20 mm, and tensile elongation and strength was determined. Examination was repeated 10 times on same conditions, and obtained average value was defined as a tensile elongation and strength of the filament.

(Heat-Shrinkage)

A filament was measured for a percentage of thermal contraction using SSC5200H thermal analysis TMA/SS 150C made by Seiko Instruments Inc. Ten filaments with a length of 10 mm were sampled, a load of 5.55 mg/dtex was applied, and a percentage of thermal contraction in a range of 30 to 280 degrees C. was measured by a heating rate of 3 degrees C./minute.

(Limiting Oxygen Index)

Sample filament of 16 cm/0.25 g was weighed, both end of the filament was lightly gathered with double-stick tape, and twist was given by a twister. When sufficient twist was fully given, the sample was folded in two at right in the middle, and the two of the sample were twisted together. End was adhered with cellophane adhesive tape, and full length was set as 7 cm. The sample was pre-dried 60 minutes at 105 degrees C., and was further dried for not less than 30 minutes in a desiccator. Dried sample was adjusted to a predetermined oxygen concentration, and was ignited from upper part with igniter thinned to 8 to 12 mm after 40 seconds. After-firing the igniter was removed. An oxygen concentration was obtained by which the sample burned not less than 5 cm or the sample continued burning not less than 3 minutes. Examination was repeated 3 times on same conditions, and a limiting oxygen index was determined.

(Drip Property)

One hundred filaments of about 50 dtex were bundled, clamped at one end by a clamp, and were fixed to a stand to be perpendicularly hung down. A flame with 20 mm was made to approach the fixed filament, and a length of 100 mm was burned. A number of drips at that time were counted, and evaluation was made on a criteria:
o: a number of drips not more than 5;
Δ: 6 to 10; and
x: not less than 11
   (Gloss)

A tow filament with length of 30 cm and gross size of 100,000 dtex were evaluated under sunlight by visual inspection.
⊚: gloss adjusted to a level similar to human hair
o: gloss adjusted moderately
Δ: a little excessive or a little insufficient gloss
x: excessive gloss, or insufficient gloss
   (Cold Setting Property)

A filament with a length of 160 mm was set straight; it was fixed with a tape and was heated for 40 minutes at 100 degrees C. The sample was cut into 85 mm after cooling to a room temperature, folded into two and both ends were connected with sewing thread. The sample was hung by a stick of 4 mmφ, a weight of 6.7 mg/dtex was attached, and were held under a condition of 30 degrees C., RH 60% for 24 hours. After the weight was removed and kept standing for 5 minutes, the sample was cut into 80 mm and a bent angle of filament was measured. This was defined as an index of crimp retentivity at low temperatures. It is most preferable to recover a state being straight (180 degrees C.).

(Curl Retentivity)

Filament bundled in a shape of a skein was wound around a pipe of 32 mmφ, and the filament was curl-set for 60 minutes at each temperature of 100 to 180 degrees C. After aging for 60 minutes at a room temperature, an end of the filament curled was fixed and hung, an initial filament length, and aged filament lengths over seven days after were investigated. This was defined as index of curl retentivity. Short initial length is preferable. It is preferable that curl-set is possible at low temperatures, and that set is possible at higher temperatures.

(Iron Setting Property)

This is an index of easiness of curl-setting and of retentivity of curl shape by a hair iron. A filament was lightly sandwiched by a hair iron heated at 180 degrees C., squeezed three times, and was preheated. Welding between filaments, smooth combing, curl of filament and yarn breakage were visually evaluated at this time. Next, a preheated filament was wound around a hair iron and held for 10 seconds, and then iron was extracted. Easiness of extracting (rod out property) and retentivity of curl when extracted at this time were evaluated by visual inspection.

### MANUFACTURING EXAMPLE 1

A polyethylene terephthalate (BELLPET EFG-10, manufactured by Kanebo Gohsen, Ltd., IV=0.60) dried by not more than 100 ppm of moisture contents 1 kg, and a polyarylate (manufactured by Unitika, Ltd. U-polymer U-100, IV=0.60) 9 kg were dry blended. The blended materials were melt-kneaded using TEX 44 with L/D=38 (made by Japan Steel Works, Ltd.) with identical direction rotation, under conditions of a cylinder preset temperature 240 to 300 degrees C., an amount of discharge 10 kg/hr, and a number of rotation 200 rpm, to obtain a polymer alloy A (intrinsic viscosity 0.74).

### MANUFACTURING EXAMPLE 2

A similar method as in Manufacturing Example 1 was repeated except for having changed an amount of the polyethylene terephthalate to be used into 2 kg, and having changed the polyarylate into 8 kg to obtain a polymer alloy B (intrinsic viscosity 0.72).

### MANUFACTURING EXAMPLE 3

A similar method as in Manufacturing Example 1 was repeated except for having changed an amount of the polyethylene terephthalate to be used into 3 kg, and having changed polyarylate into 7 kg to obtain a polymer alloy C (intrinsic viscosity 0.64).

### EXAMPLES 1 to 10

A polyester pellet PESM6100 BLACK for coloring (manufactured by Dainichiseika Colour & Chemicals Mfg. Co., Ltd., 30% of carbon black contents: content is included in the component (A) as polyester) 2 parts by weight was added and dry-blended to compositions having ratios shown in Table 1 including a raw resin dried to not more than 100 ppm moisture content; phosphorus based flame resistant agents (where, since a polyester copolymerized with a phosphorus based flame resistant agent was used in Example 10, additional phosphorus based flame resistant agent was not used); phosphite based compound; organic fine particles; and inorganic fine particles. The obtained blended materials were supplied to a twin screw extruder, and melt kneaded at 280 degrees C., pelletized, and subsequently dried to not more than 100 ppm of moisture content. Subsequently, molten polymers were extruded from a spinneret having circle section holes of 0.5 mm of diameters of nozzle, using a melt spinning machine at 280 degrees C. The obtained filaments were cooled in a water bath with a water temperature of 50 degrees C. installed in a position of 30 mm under the nozzle, and taken up at a rate of 100 m /minute to obtain undrawn yarns. The obtained undrawn yarns were drawn in a warm water bath at 80 degrees C. to provide four times drawn yarns. The drawn yarns were taken up using a heat roll heated at 200 degrees C., and at a rate of 100 m/minute to be heat-treated. Polyester fibers (multifilament) having a shape of non-crimp flat yarns and a single fiber fineness of about 50 dtex were obtained.

TABLE 1

| | EXAMPLE | | | | | | | | | |
|---|---|---|---|---|---|---|---|---|---|---|
| | 1 | 2 | 3 | 4 | 5 | 6 | 7 | 8 | 9 | 10 |
| Polyethylene | 80 | 80 | 60 | 80 | 80 | 80 | 80 | 80 | 80 | |
| terephthalate *¹ | | | | | | | | | | |
| Flame resistant agent | | | | | | | | | | 8.5 |
| copolymerized | | | | | | | | | | |
| polyester *² | | | | | | | | | | |
| Polymer alloy A | 20 | 20 | 40 | | | | | | | |
| Polymer alloy B | | | | 20 | 20 | 20 | 20 | 20 | | 15 |
| Polymer alloy C | | | | | | | | | 20 | |
| Condensed phosphoric | 10 | 10 | 10 | 10 | 10 | 10 | 10 | 10 | 10 | |
| acid ester *³ | | | | | | | | | | |
| Phosphite based | 1 | 1 | 1 | 1 | 1 | 1 | 1 | 1 | 1 | 1 |
| compound *⁴ | | | | | | | | | | |
| Silicone rubber *⁵ | | | | | 2 | | | | | |
| Polyarylate *⁶ | | 3 | | | | 5 | | | | |
| Titanium oxide *⁷ | | | | | | | 0.6 | | 1 | |
| Talc *⁸ | | | | | | | | 1 | | 1 |

*1: Manufactured by Kanebo Gohsen, Ltd., BELLPET EFG-85A, IV = 0.85
*2: Manufactured by HUVIS, STB-3, phosphorus atom content 0.7%
*3: Manufactured by DAIHACHI CHEMICAL INDUSTRY CO., LTD., PX-200, phosphorus atom content 9%
*4: Manufactured by Asahi Denka Kogyo K. K., ADKSTAB PEP-36
*5: Manufactured by Dow Corning Toray Silicone, TORAYFIL E-500
*6: Manufactured by Unitika, Ltd., U-polymer U-100, IV = 0.60
*7: Ishihara Sangyo Kaisha, Ltd., TIPAQUE CR-GO
*8: NIPPON TALC CO., LTD., Micron Ace K-1
The obtained fibers was evaluate for a tensile elongation and strength, a percentage of thermal contraction, a limiting oxygen index, drip-proof property, gloss, cold setting property, a curl retentivity, and iron setting property. Table 2 shows results.

TABLE 2

| | | EXAMPLE | | | | | | | | | |
|---|---|---|---|---|---|---|---|---|---|---|---|
| | | 1 | 2 | 3 | 4 | 5 | 6 | 7 | 8 | 9 | 10 |
| Size of a fiber (dtex) | | 47 | 49 | 48 | 47 | 49 | 50 | 48 | 47 | 49 | 52 |
| Strength (cN/dtex) | | 2.3 | 2.1 | 1.7 | 2.2 | 1.8 | 2.3 | 2.2 | 2.3 | 1.9 | 1.8 |
| Elongation (%) | | 61 | 55 | 45 | 74 | 57 | 67 | 73 | 73 | 82 | 63 |
| Shrinkage percentage of 180 | | 3 | 3 | 3 | 2 | 2 | 2 | 2 | 2 | 4 | 4 |
| degrees C. (%) | | | | | | | | | | | |
| Limiting oxygen index | | 26.2 | 26.3 | 26.1 | 25.3 | 25.1 | 25.5 | 25.2 | 25.2 | 25.8 | 26.5 |
| Drip-proof property | | ◯ | ◯ | ◯ | ◯ | ◯ | ◯ | ◯ | ◯ | ◯ | Δ |
| Gloss | | ◯ | ⊚ | ⊚ | ◯ | ◯ | ⊚ | ⊚ | ⊚ | ◯ | ◯ |
| Cold setting property | | 118 | 120 | 114 | 116 | 119 | 121 | 116 | 116 | 112 | 110 |
| Curl | Initial length | 16.0 | 15.8 | 16.2 | 16.0 | 16.0 | 15.7 | 16.2 | 16.2 | 16.4 | 16.8 |
| retentivity | (cm) | | | | | | | | | | |
| (100-degree | Seven days | 18.9 | 18.5 | 19.2 | 19.1 | 18.8 | 18.3 | 19.1 | 19.1 | 19.4 | 19.9 |
| C. set) | after (cm) | | | | | | | | | | |
| | Elongation | 18.0 | 17.2 | 18.4 | 18.2 | 17.6 | 16.8 | 18.2 | 18.2 | 18.4 | 18.7 |
| | percentage | | | | | | | | | | |
| | (%) | | | | | | | | | | |
| Iron setting | Welding | ◯ | ◯ | ◯ | ◯ | ◯ | ◯ | ◯ | ◯ | ◯ | ◯ |
| property | | | | | | | | | | | |
| (180-degree C. | Curl/yarn | ◯ | ◯ | ◯ | ◯ | ◯ | ◯ | ◯ | ◯ | ◯ | Δ |
| set) | breakage | | | | | | | | | | |
| | Rod out property | ◯ | ◯ | ◯ | ◯ | ◯ | ◯ | ◯ | ◯ | Δ | ◯ |
| | Curl | ◯ | ◯ | ◯ | ◯ | ◯ | ◯ | ◯ | ◯ | ◯ | ◯ |
| | retentivity | | | | | | | | | | |

### COMPARATIVE EXAMPLE 1

To a polyethylene terephthalate (BELLPET EFG-10, manufactured by Kanebo Gohsen, Ltd.) dried by not more than 100 ppm of moisture contents 100 parts by weight, triphenyl phosphate 10 parts by weight, and polyester pellet PESM6100 BLACK (manufactured by Dainichiseika Colour & Chemicals Mfg. Co., Ltd., 30% of carbon black contents) for coloring 2 parts by weight were added and dry-blended. Molten polymer was extruded using a spinneret having circle section nozzle hole of 0.5 mm of diameters, was cooled in a water bath with water at a temperature of 30 degrees C. installed in a position of 25 cm under the nozzle, and taken up at a rate of 100 m/minute to obtain undrawn yarns. The obtained undrawn yarns were drawn in a warm water bath at 80 degrees C. to obtain four times drawn yarns. The drawn yarns were taken up using a heat roll heated at 200 degrees C., and at a rate of 100 m/minute to be heat-treated. Polyester fibers (multifilament) having a single fiber fineness of about 52 dtex were obtained.

### COMPARATIVE EXAMPLE 2

To a polyethylene terephthalate (BELLPET EFG-10, manufactured by Kanebo Gohsen, Ltd.) 100 parts by weight, 1,3-phenylene bis(dixylenyl phosphate) 10 parts by weight, a polyarylate (U polymer U-100, manufactured by Unitika, Ltd.) 5 parts by weight, and a polyester pellet PESM6100 BLACK (manufactured by Dainichiseika Colour & Chemicals Mfg. Co., Ltd., 30% of carbon black contents) for coloring 1.5 parts by weight were added, and a same step as in Comparative Example 1 was repeated to obtain a heat-shrinkable polyester fiber (multifilament) having a single fiber fineness of 50 dtex.

### COMPARATIVE EXAMPLE 3

To a polyethylene terephthalate (BELLPET EFG-10, manufactured by Kanebo Gohsen, Ltd.) 100 parts by weight, 1,3-phenylene bis(dixylenyl phosphate) 10 parts by weight, titanium oxide 1 part by weight, and polyester pellet PESM6100 BLACK (manufactured by Dainichiseika Colour & Chemicals Mfg. Co., Ltd., 30% of carbon black contents) for coloring 1.5 parts by weight were added, and a same step as in Comparative Example 1 was repeated to obtain a heat-shrinkable polyester fiber (multifilament) having a single fiber fineness of 48 dtex. The obtained fibers was evaluate for a tensile elongation and strength, a percentage of thermal contraction, a limiting oxygen index, drip-proof property, gloss, cold setting property, a curl retentivity, and iron setting property. Table 3 shows results.

TABLE 3

Comparative Example

| | | |
|---|---|---|
| 1 | 2 | 3 |

| Size of a fiber (dtex) | | 46 | 48 | 49 |
|---|---|---|---|---|
| Strength (cN/dtex) | | 2.2 | 2.0 | 2.4 |
| Elongation (%) | | 68 | 63 | 64 |
| Shrinkage percentage of | | 4 | 8 | 6 |
| 180 degrees C. (%) | | | | |
| Limiting oxygen index | | 24.8 | 25.8 | 25.1 |
| Drip-proof property | | x | x | x |
| Gloss | | x | Δ | Δ |
| Cold setting property | | 102 | 115 | 105 |
| Curl | Initial | 18.0 | 16.5 | 18.0 |
| retentivity | length (cm) | | | |
| (100-degree | Seven days | 22.5 | 19.4 | 22.2 |
| C. set) | after (cm) | | | |
| | Elongation | 25.0 | 17.5 | 23.5 |
| | percentage | | | |
| | (%) | | | |
| Iron | Welding | x | x | x |
| setting | Curl/yarn | Δ | Δ | Δ |
| property | breakage | | | |
| (180-degree | Rod out | x | x | x |
| C. set) | property | | | |
| | Curl | ◯ | ◯ | ◯ |
| | retentivity | | | |

### INDUSTRIAL APPLICABILITY

According to the present invention, a flame resistant polyester fiber, while maintaining physical properties, such as heat resistance, tensile strength and elongation etc. of usual polyester fibers, having excellent flame resistance and excellent setting property, and controlled gloss may be obtained.

1. An artificial hair consisting of a flame resistant polyester fiber, the flame resistant polyester fiber comprising:
a polyester (A) selected from a polyalkylene terephthalate one or more kinds of copolymerized polyesters having polyalkylene terephthalate as a principal component;
a polymer alloy (B) consisting of a polyalkylene terephthalates and a polyarylates;
a phosphorus based flame resistant agent (C); and a phosphite based compound (D).

2. The artificial hair consisting of a flame resistant polyester fiber according to claim 1, wherein a weight ratio of the polyester component (A) and the polymer alloy component (B) is (A)/(B)=90/10 to 50/50, the phosphorus based flame resistant agent component (C) is in terms of phosphorus atomic weight 0.05 to 10 parts by weight, and the phosphite based compound component (D) is 0.05 to 5 parts by weight, to a total amount of the component (A) and the component (B) 100 parts by weight.

3. The artificial hair consisting of a flame resistant polyester fiber according to claim 1, wherein the polyester component (A) is at least one kind of polymers selected from a group consisting of polyethylene terephthalates, polypropylene terephthalates, and polybutylene terephthalates.

4. The artificial hair consisting of a flame resistant polyester fiber according to claim 1, wherein the polymer alloy component (B) is an polymer alloy consisting of:
at least one kind of polyalkylene terephthalates selected from a group consisting of polyethylene terephthalates, polypropylene terephthalates, and polybutylene terephthalates; and a polyarylate obtained from a mixture of terephthalic acid and/or terephthalic acid derivatives and isophthalic acid and/or isophthalic acid derivatives, and bisphenol compounds represented with a general formula (1): 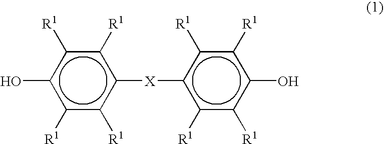
(where, R¹ is hydrogen atom, or hydrocarbon group with 1 to 10 carbon atoms, and may be identical or different respectively, X represents methylene group, ethylidene group, isopropylidene group, carbonyl group, sulfonyl group, 1,3-phenylene diisopropylidene group or 1,4-phenylene diisopropylidene group.)

5. The artificial hair consisting of a flame resistant polyester fiber according to claim 1, wherein the phosphorus based flame resistant agent component (C) is at least one kind of compounds selected from a group consisting of:
phosphate based compounds, phosphonate based compounds, phosphinate based compounds, phosphine oxide based compounds, phosphonite based compound, phosphinite based compounds, phosphine based compounds, and condensed phosphoric acid ester compounds.

6. The artificial hair consisting of a flame resistant polyester fiber according to claim 5, wherein the phosphorus based flame resistant agent component (C) is a condensed phosphoric acid ester compound represented with a general formula (2): 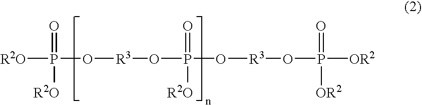
(where, R² is monovalent aromatic hydrocarbon group or aliphatic hydrocarbon group, which may be identical of different respectively, R³ is a divalent aromatic hydrocarbon group, and when two or more are included they may be identical or different respectively, n represents an integer of 0 to 15.)

7. The artificial hair consisting of a flame resistant polyester fiber according to claim 1, wherein the component (C) is a reactive phosphorus based flame resistant agent being copolymerizable with the component (A).

8. The artificial hair consisting of a flame resistant polyester fiber according to claim 7, wherein the reactive phosphorus based flame resistant agent is at least one kind selected from a group consisting of phosphorated compounds represented with general formulas (3) to (8): 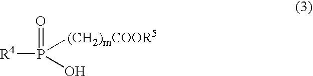
(where, R⁴ is aliphatic hydrocarbon group with 1 to 20 carbon atoms or aromatic hydrocarbon group with 6 to 12 carbon atoms, R⁵ is hydrogen atom or aliphatic hydrocarbon group with 1 to 20 carbon atoms, m represents an integer of 1 to 11); 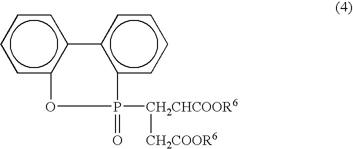
(where, R⁶ is hydrogen atom or aliphatic hydrocarbon group with 1 to 20 carbon atoms, and they may be identical or different respectively); 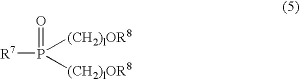
(where, R⁷ is aliphatic hydrocarbon group with 1 to 20 carbon atoms or aromatic hydrocarbon group with 1 to 12 carbon atoms, R⁸ is hydrogen atom or aliphatic hydrocarbon group with 1 to 20 carbon atoms, and they may be identical or different respectively, and 1 represents an integer of 1 to 12); 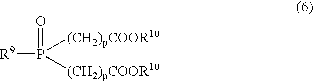
(where, R⁹ is an aliphatic hydrocarbon group with 1 to 20 carbon atoms or aromatic hydrocarbon group with 6 to 12 carbon atoms, R¹⁰ is hydrogen atom or aliphatic hydrocarbon group with 1 to 20 carbon atoms, they may be identical or different respectively, and p represents an integer of 1 to 11); 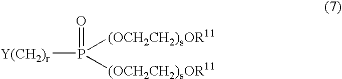
(where, R¹¹ is hydrogen atom or aliphatic hydrocarbon group with 1 to 20 carbon atoms, and they may be identical or different respectively, and Y is hydrogen atom, methyl group, or aromatic hydrocarbon group with 6 to 12 carbon atoms, and r and s represent integers of 1 to 20, respectively); and 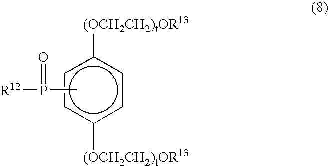
(where, R¹² is aliphatic hydrocarbon group with 1 to 20 carbon atoms or aromatic hydrocarbon group with 6 to 12 carbon atoms, R¹³ is hydrogen atom or aliphatic hydrocarbon group with 1 to 20 carbon atoms, and they may be identical or different respectively, and t represents an integer of 1 to 20.)

9. The artificial hair consisting of a flame resistant polyester fiber according to claim 1, wherein the phosphite based compound component (D) is at least one kind selected from a group consisting of trialkyl phosphites, tri aryl phosphites, alkyl aryl phosphites, and phosphite based compounds represented with general formulas (9) to (12): 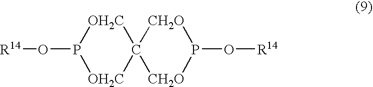
(where, R¹⁴ is linear or branched hydrocarbon group with 4 to 20 carbon atoms, and they may be identical or different respectively); 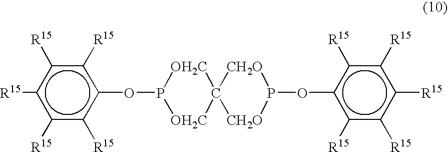
(where, R¹⁵ is hydrogen atom or hydrocarbon group with 1 to 10 carbon atoms, and they may be identical or different respectively); 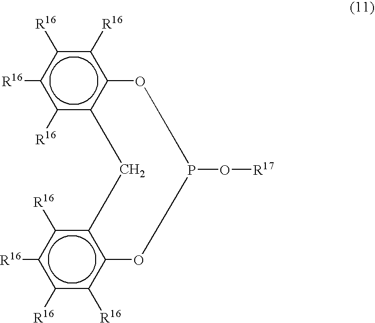
(where, R¹⁶ is hydrogen atom or hydrocarbon group with 1 to 10 carbon atoms, and they may be identical or different respectively, and R¹⁷ is hydrocarbon group with 4 to 20 carbon atoms or aromatic hydrocarbon group with 6 to 20 carbon atoms); and 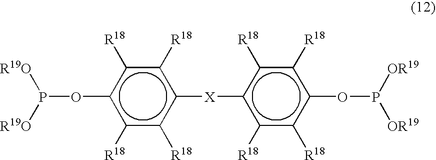
(where, R¹⁸ is hydrogen atom or hydrocarbon group with 1 to 10 carbon atoms, and they may be identical or different respectively, and R¹⁹ is hydrocarbon group with 4 to 20 carbon atoms or aromatic hydrocarbon group with 6 to 20 carbon atoms and they may be identical or different respectively, and X represents methylene group, ethylidene group, isopropylidene group, carbonyl group, sulfonyl group, 1,3-phenylene diisopropylidene group or 1,4-phenylene diisopropylidene group.)

10. The artificial hair consisting of a flame resistant polyester fiber according to claim 1, wherein organic fine particles (E) and/or inorganic fine particles (F) are further mixed therein.

11. The artificial hair consisting of a flame resistant polyester fiber according to claim 10, wherein the organic fine particle component (E) is at least one kind selected from a group consisting of polyarylates, polyamides, fluororesins, silicone resins, cross-linked acrylate resins, and cross-linked polystyrenes.

12. The artificial hair consisting of a flame resistant polyester fiber according to claim 10, wherein the inorganic fine particles component (F) is at least one kind selected from a group consisting of calcium carbonate, silicon oxide, titanium oxides, aluminum oxide, zinc oxide, talc, kaolin, montmorillonite, bentonite, and mica.

13. The artificial hair consisting of a flame resistant polyester fiber according to claim 1, wherein the flame resistant polyester fiber has non-crimped flat yarn shape.

14. The artificial hair consisting of a flame resistant polyester fiber according to claim 1, wherein the flame resistant polyester fiber is spun dyed.

15. The artificial hair consisting of a flame resistant polyester fiber according to claim 1, wherein the ratio by weight of the polyalkylene terephtahalate and the polyarylate in the polymer alloy component (B) is from 5/95 to 50/50.

16. The artificial hair consisting of a flame resistant polyester fiber according to claim 1, wherein the ratio by weight of the polyalkylene terephtahalate and the polyarylate in the polymer alloy component (B) is from 5/95 to 50/50, and the ratio by weight of the polyester (A) and the polymer alloy component (B) is from 90/10 to 50/50.

17. A method for preparing an artificial hair consisting of a flame resistant polyester fiber comprising;
preparing a polyester composition comprising:
a polyester (A) selected from a polyalkylene terephthalate and one or more kinds of copolymerized polyesters having a polyalkylene terephthalate as a principal component;
a polymer alloy (B) consisting of a polyalkylene terephthalates and a polyarylate;
a phosphorus based flame resistant agent (C); and
a phosphite based compound (D) and
melt spinning the composition to make a flame resistant polyester fiber.

18. The method of preparing an artificial hair consisting of a flame resistant polyester fiber according to claim 17, wherein a weight ratio of the polyester component (A) and the polymer alloy component (B) is (A)/(B)=90/10 to 50/50, the phosphorus based flame resistant agent component (C) is in terms of phosphorus atomic weight 0.05 to 10 parts by weight, and the phosphite based compound component (D) is 0.05 to 5 parts by weight, to a total amount of the component (A) and the component (B) 100 parts by weight.

19. The method of preparing an artificial hair consisting of a flame resistant polyester fiber according to claim 17, wherein the polyester component (A) is at least one kind of polymers selected from a group consisting of polyethylene terephthalates, polypropylene terephthalates, and polybutylene terephthalates.

20. The method of preparing an artificial hair consisting of a flame resistant polyester fiber according to claim 17, wherein the polymer alloy component (B) is an polymer alloy consisting of:
at least one kind of polyalkylene terephthalates selected from a group consisting of polyethylene terephthalates, polypropylene terephthalates, and polybutylene terephthalates; and a polyarylate obtained from a mixture of terephthalic acid and/or terephthalic acid derivatives and isophthalic acid and/or isophthalic acid derivatives, and bisphenol compounds represented with a general formula (1): 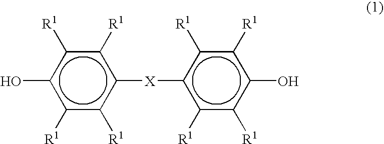
(where, R¹ is hydrogen atom, or hydrocarbon group with 1 to 10 carbon atoms, and may be identical or different respectively, X represents methylene group, ethylidene group, isopropylidene group, carbonyl group, sulfonyl group, 1,3-phenylene diisopropylidene group or 1,4-phenylene diisopropylidene group.)

21. The method of preparing an artificial hair consisting of a flame resistant polyester fiber according to claim 17, wherein the phosphorus based flame resistant agent component (C) is at least one kind of compounds selected from a group consisting of:
phosphate based compounds, phosphonate based compounds, phosphinate based compounds, phosphine oxide based compounds, phosphonite based compound, phosphinite based compounds, phosphine based compounds, and condensed phosphoric acid ester compounds.

22. The method of preparing an artificial hair consisting of a flame resistant polyester fiber according to claim 21, wherein the phosphorus based flame resistant agent component (C) is a condensed phosphoric acid ester compound represented with a general formula (2): 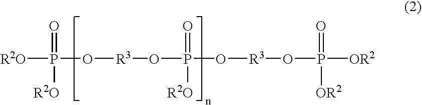
(where, R² is monovalent aromatic hydrocarbon group or aliphatic hydrocarbon group, which may be identical of different respectively, R³ is a divalent aromatic hydrocarbon group, and when two or more are included they may be identical or different respectively, n represents an integer of 0 to 15.)

23. The method of preparing an artificial hair consisting of a flame resistant polyester fiber according to claim 17, wherein the component (C) is a reactive phosphorus based flame resistant agent being copolymerizable with the component (A).

24. The method of preparing an artificial hair consisting of a flame resistant polyester fiber according to claim 24, wherein the reactive phosphorus based flame resistant agent is at least one kind selected from a group consisting of phosphorated compounds represented with general formulas (3) to (8): 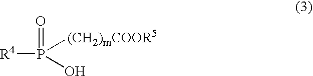
(where, R⁴ is aliphatic hydrocarbon group with 1 to 20 carbon atoms or aromatic hydrocarbon group with 6 to 12 carbon atoms, R⁵ is hydrogen atom or aliphatic hydrocarbon group with 1 to 20 carbon atoms, m represents an integer of 1 to 11); 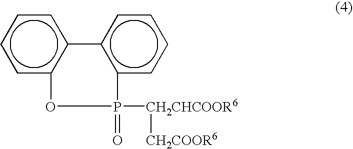
(where, R⁶ is hydrogen atom or aliphatic hydrocarbon group with 1 to 20 carbon atoms, and they may be identical or different respectively); 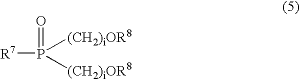
(where, R⁷ is aliphatic hydrocarbon group with 1 to 20 carbon atoms or aromatic hydrocarbon group with 1 to 12 carbon atoms, R⁸ is hydrogen atom or aliphatic hydrocarbon group with 1 to 20 carbon atoms, and they may be identical or different respectively, and 1 represents an integer of 1 to 12); 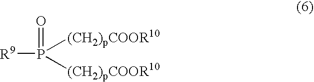
(where, R⁹ is an aliphatic hydrocarbon group with 1 to 20 carbon atoms or aromatic hydrocarbon group with 6 to 12 carbon atoms, R¹⁰ is hydrogen atom or aliphatic hydrocarbon group with 1 to 20 carbon atoms, they may be identical or different respectively, and p represents an integer of 1 to 11); 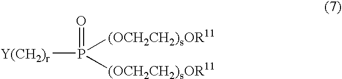
(where, R¹¹ is hydrogen atom or aliphatic hydrocarbon group with 1 to 20 carbon atoms, and they may be identical or different respectively, and Y is hydrogen atom, methyl group, or aromatic hydrocarbon group with 6 to 12 carbon atoms, and r and s represent integers of 1 to 20, respectively); and 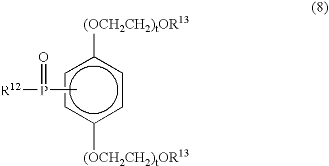
(where, R¹² is aliphatic hydrocarbon group with 1 to 20 carbon atoms or aromatic hydrocarbon group with 6 to 12 carbon atoms, R¹³ is hydrogen atom or aliphatic hydrocarbon group with 1 to 20 carbon atoms, and they may be identical or different respectively, and t represents an integer of 1 to 20.)

25. The method of preparing an artificial hair consisting of a flame resistant polyester fiber according to claim 24, wherein the phosphite based compound component (D) is at least one kind selected from a group consisting of trialkyl phosphites, tri aryl phosphites, alkyl aryl phosphites, and phosphite based compounds represented with general formulas (9) to (12): 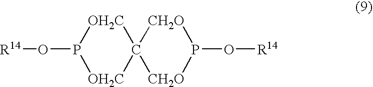
(where, R¹⁴ is linear or branched hydrocarbon group with 4 to 20 carbon atoms, and they may be identical or different respectively); 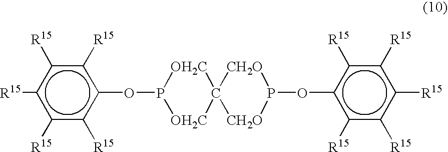
(where, R¹⁵ is hydrogen atom or hydrocarbon group with 1 to 10 carbon atoms, and they may be identical or different respectively); 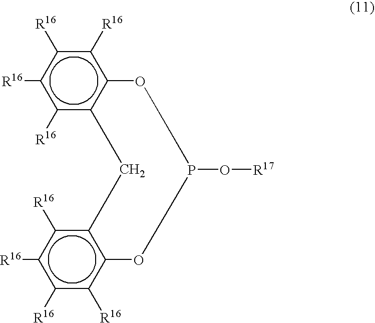
(where, R¹⁶ is hydrogen atom or hydrocarbon group with 1 to 10 carbon atoms, and they may be identical or different respectively, and R¹⁷ is hydrocarbon group with 4 to 20 carbon atoms or aromatic hydrocarbon group with 6 to 20 carbon atoms); and 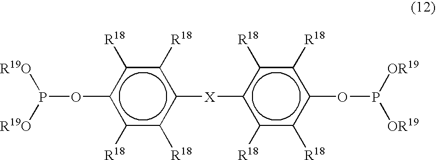
(where, R¹⁸ is hydrogen atom or hydrocarbon group with 1 to 10 carbon atoms, and they may be identical or different respectively, and R¹⁹ is hydrocarbon group with 4 to 20 carbon atoms or aromatic hydrocarbon group with 6 to 20 carbon atoms and they may be identical or different respectively, and X represents methylene group, ethylidene group, isopropylidene group, carbonyl group, sulfonyl group, 1,3-phenylene diisopropylidene group or 1,4-phenylene diisopropylidene group.)

26. The method of preparing an artificial hair consisting of a flame resistant polyester fiber according to claim 17, wherein organic fine particles (E) and/or inorganic fine particles (F) are further mixed therein.

27. The method of preparing an artificial hair consisting of a flame resistant polyester fiber according to claim 17, wherein the organic fine particle component (E) is at least one kind selected from a group consisting of polyarylates, polyamides, fluororesins, silicone resins, cross-linked acrylate resins, and cross-linked polystyrenes.

28. The method of preparing an artificial hair consisting of a flame resistant polyester fiber according to claim 17, wherein the inorganic fine particles component (F) is at least one kind selected from a group consisting of calcium carbonate, silicon oxide, titanium oxides, aluminum oxide, zinc oxide, talc, kaolin, montmorillonite, bentonite, and mica.

29. The method of preparing an artificial hair consisting of a flame resistant polyester fiber according to claim 17, wherein the flame resistant polyester fiber has non-crimped flat yarn shape.

30. The method of preparing an artificial hair consisting of a flame resistant polyester fiber according to claim 30, wherein the flame resistant polyester fiber is spun dyed.

31. The method of preparing an artificial hair consisting of a flame resistant polyester fiber according to claim 17, wherein the ratio by weight of the polyalkylene terephtahalate and the polyarylate in the polymer alloy component (B) is from 5/95 to 50/50.

32. The method of preparing an artificial hair consisting of a flame resistant polyester fiber according to claim 17, wherein the ratio by weight of the polyalkylene terephtahalate and the polyarylate in the polymer alloy component (B) is from 5/95 to 50/50, and the ratio by weight of the polyester (A) and the polymer alloy component (B) is from 90/10 to 50/50.
